(19) United States
(12) Patent Application Publication
(10) Pub. No.: US 2010/0232356 A1
(43) Pub. Date: Sep. 16, 2010

(54) LAYER TWO SEGMENTATION TECHNIQUES FOR HIGH DATA RATE TRANSMISSIONS

(75) Inventors: Shailesh Maheshwari, San Diego, CA (US); Liangchi Hsu, San Diego, CA (US); Aziz Gholmieh, Del Mar, CA (US); Rohit Kapoor, San Diego, CA (US); Etienne F. Chaponniere, Rome (IT); Danlu Zhang, San Diego, CA (US); Jeremy H. Lin, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/720,486

(22) Filed: Mar. 9, 2010

Related U.S. Application Data
(60) Provisional application No. 61/160,414, filed on Mar. 16, 2009.

(51) Int. Cl. H04W 40/00

(52) U.S. Cl. 370/328

(57) ABSTRACT

A method, an apparatus, and a computer program product for wireless communication are provided to enable a reduction in processing power while handling high data rates. An apparatus includes a processing system configured to service a MAC PDU. Here, the MAC PDU includes a MAC header and at least one MAC SDU. The MAC header includes a transmission sequence number (TSN) having a length greater than 6 bits. Further, the processing system is configured to read the MAC header and to transport the MAC PDU in accordance with the MAC header between a MAC and a PHY utilizing one or more transport blocks over one or more transport channels.

### CROSS-REFERENCE TO RELATED APPLICATION(S)

Pursuant to 35 U.S.C. §119(e), this application claims the benefit of U.S. Provisional Application Ser. No. 61/160,414, titled “LAYER TWO SEGMENTATION TECHNIQUES FOR HIGH DATA RATE TRANSMISSIONS,” filed on Mar. 16, 2009 and assigned to the assignee hereof, the contents of which are hereby incorporated by reference herein in their entirety.

### BACKGROUND

1. Field

The present disclosure relates generally to communication systems, and more particularly, to packet data management in the MAC and RLC layers of a radio access network.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, and single-carrier frequency divisional multiple access (SC-FDMA) systems.

These multiple access technologies have been adopted in various telecommunication standards to provide a common protocol that enables different wireless devices to communicate on a municipal, national, regional, and even global level. An example of a telecommunication standard is Universal Mobile Telecommunications System (UMTS), promulgated by Third Generation Partnership Project (3GPP).

In the 3GPP Release 8 specification, a Dual Carrier (DC) is available for High Speed Packet Access (DC-HSPA) systems. In the forthcoming release 9 specification, Multiple Input-Multiple Output (MIMO) antenna technology may be utilized on these two carriers. Thus, each carrier may utilize multiple streams, theoretically resulting in very high data rates. Still further improvements beyond these changes may be implemented in future releases. These high data rates generally result high processing requirements, as large number of data packets must be processed by User Equipment (UE) such as a mobile phone, reducing battery life and requiring ever-improved hardware.

Thus, as the demand for mobile broadband access continues to increase, there exists a need for further improvements in UMTS technology, including the rapid processing and handling of the large volumes of data packets that result from the increased data rates. Preferably, these improvements should be applicable to other multi-access technologies and the telecommunication standards that employ these technologies.

### SUMMARY

With the enablement of very high data rates in modern wireless telecommunications technology, it becomes more efficient to include more information in each packet, such that the processing power required for each packet is reduced, at the expense of increases in the amount of data.

Thus, in an aspect of the disclosure, an apparatus for wireless communication over a radio link includes a processing system configured to service a MAC protocol data unit (PDU). Here, the MAC PDU includes a MAC header and at least one MAC service data unit (SDU). The MAC header includes a transmission sequence number (TSN) having a length greater than 6 bits. Further, the processing system is configured to read the MAC header and to transport the MAC PDU in accordance with the MAC header between a MAC and a PHY utilizing one or more transport blocks over one or more transport channels.

In another aspect of the disclosure, an apparatus for wireless communication over a radio link utilizing a MAC layer and an RLC layer includes a processing system configured to service an RLC PDU, the RLC PDU including an RLC header and an RLC payload. Here, the RLC payload includes at least one RLC SDU. The RLC header includes an RLC sequence number and an information element 840 for indicating the number of RLC SDUs in the RLC PDU. Further, the processing system is configured to read the RLC header and to send the RLC PDU in accordance with the RLC header between the RLC layer and the MAC layer utilizing one or more logical channels.

In yet another aspect of the disclosure, a method of wireless communication over a radio link includes servicing a MAC PDU comprising a MAC header and at least one MAC SDU. Here, the MAC header includes a TSN having a length greater than 6 bits. The MAC header is read and the MAC PDU is transported in accordance with the MAC header between a MAC layer and a PHY layer utilizing one or more transport blocks over one or more transport channels.

In yet another aspect of the disclosure, a method for wireless communication over a radio link utilizing a MAC layer and an RLC layer includes servicing an RLC PDU including an RLC header and an RLC payload including at least one RLC SDU.

Here, the RLC header includes an RLC sequence number and an information element for indicating a number of RLC SDUs in the RLC PDU. The RLC header is read, and the RLC PDU is sent in accordance with the RLC header between an RLC layer and a MAC layer utilizing one or more logical channels.

In yet another aspect of the disclosure, an apparatus for wireless communication includes means for servicing a MAC PDU including a MAC header and at least one MAC SDU, the MAC header including a TSN having a length greater than 6 bits. The apparatus further includes means for reading the MAC header and means for transporting the MAC PDU in accordance with the MAC header between a MAC layer and a PHY layer utilizing one or more transport blocks over one or more transport channels.

In yet another aspect of the disclosure, an apparatus for wireless communication over a radio link utilizing a MAC layer and an RLC layer includes means for servicing an RLC PDU including an RLC header and an RLC payload, the RLC payload including at least one RLC SDU. Here, the RLC header includes an RLC sequence number and an information element for indicating a number of RLC SDUs in the RLC PDU. The apparatus further includes means for reading the RLC header and means for sending the RLC PDU in accordance with the RLC header between an RLC layer and a MAC layer utilizing one or more logical channels.

In yet another aspect of the disclosure, a computer program product includes a computer-readable medium with code for servicing a MAC PDU including a MAC header and at least one MAC SDU, the MAC header having a TSN having a length greater than 6 bits. The code is further for reading the MAC header and transporting the MAC PDU in accordance with the MAC header between a MAC layer and a PHY layer utilizing one or more transport blocks over one or more transport channels.

In yet another aspect of the disclosure, a computer program product includes a computer-readable medium with code for servicing an RLC PDU having an RLC header and an RLC payload, the RLC payload including at least one RLC SDU. Here, the RLC header includes an RLC sequence number and an information element for indicating a number of RLC SDUs in the RLC PDU. The code is further for reading the RLC header and sending the RLC PDU in accordance with the RLC header between an RLC layer and a MAC layer utilizing one or more logical channels.

These and other aspects are more fully comprehended upon review of this disclosure.

### BRIEF DESCRIPTION OF THE DRAWINGS

FIG. 1 is a conceptual diagram illustrating an example of a hardware implementation for an apparatus employing a processing system.

FIG. 2 is a conceptual diagram illustrating an example of a network architecture.

FIG. 3 is a conceptual diagram illustrating an example of an access network.

FIG. 4 is a conceptual diagram illustrating an example of a radio protocol architecture for the user and control plane.

FIG. 5 is a conceptual diagram illustrating an example of a Node B and UE in an access network.

FIG. 6 is a bit map and table illustrating an RLC PDU according to the prior art.

FIG. 7 is a bit map illustrating an RLC PDU according to an aspect of the disclosure.

FIG. 8 is a schematic illustration of a cipher block according to the prior art.

FIG. 9 is a bit map illustrating an RLC PDU according to an aspect of the disclosure.

FIG. 10 is a bit map illustrating a MAC-ehs PDU according to the prior art.

FIGS. 11-13 are bit maps illustrating MAC-ehs PDUs according to aspects of the disclosure.

FIGS. 14-15 are flow charts illustrating processes according to aspects of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawing by various blocks, modules, components, circuits, steps, processes, algorithms, etc. (collectively referred to as “elements”). These elements may be implemented using electronic hardware, computer software, or any combination thereof. Whether such elements are is implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, a carrier wave, a transmission line, or any other suitable medium for storing or transmitting software. The computer-readable medium may be resident in the processing system, external to the processing system, or distributed across multiple entities including the processing system. Computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

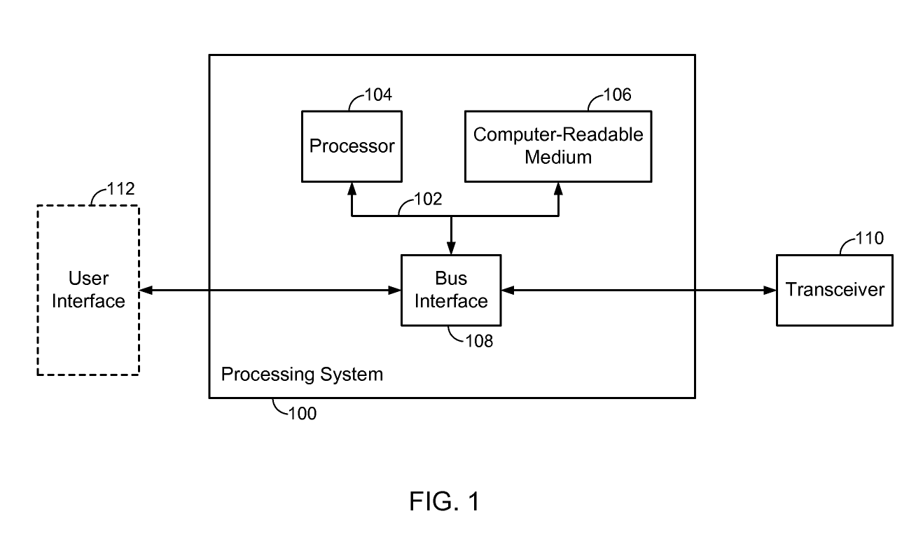

FIG. 1 is a conceptual diagram illustrating an example of a hardware implementation for an apparatus employing a processing system. In this example, the processing system 100 may be implemented with a bus architecture, represented generally by bus 102. The bus 102 may include any number of interconnecting buses and bridges depending on the specific application of the processing system 100 and the overall design constraints. The bus links together various circuits including one or more processors, represented generally by processor 104, and computer-readable media, represented generally by computer-readable medium 106. The bus 102 may also link various other circuits such as timing sources, peripherals, voltage regulators, power management circuits, and the like, which are well known in the art, and therefore, will not be described any further. A bus interface 108 provides an interface between the bus 102 and a transceiver 110. The transceiver 110 provides a means for communicating with various other apparatus over a transmission medium. Depending upon the nature of the apparatus, a user interface 112 (e.g., keypad, display, speaker, microphone, joystick, etc.) may also be provided.

The processor 104 is responsible for managing the bus and general processing, including the execution of software stored on the computer-readable medium 106. The software, when executed by the processor 104, cause the processing system 100 to perform the various functions described below for any particular apparatus. The computer-readable medium 106 may also be used for storing data that is manipulated by the processor 104 when executing software.

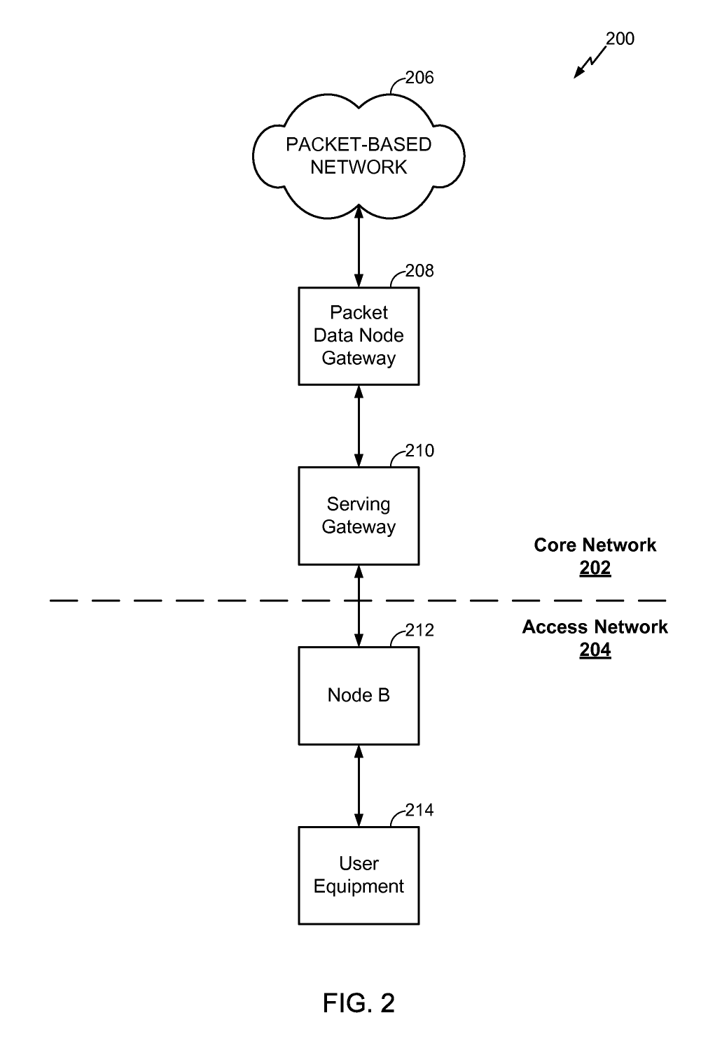

An example of a telecommunications system employing various apparatus will now be presented with reference to a UMTS network architecture as shown in FIG. 2. The UMTS network architecture 200 is shown with a core network 202 and an access network 204. Generally, in a UMTS network, the access network 204 is referred to as a UMTS Terrestrial Radio Access Network (UTRAN). In this example, the core network 202 provides packet-switched services to the access network (UTRAN) 204, however, as those skilled in the art will readily appreciate, the various concepts presented throughout this disclosure may be extended to core networks providing circuit-switched services.

The access network 204 is shown with a single apparatus 212, which is commonly referred to as a Node B in UMTS applications, but may also be referred to by those skilled in the art as a base station, a base transceiver station, a radio base station, a radio transceiver, a transceiver function, a basic service set (BSS), an extended service set (ESS), or some other suitable terminology. The Node B 212 provides an access point to the core network 202 for a mobile apparatus 214. Examples of a mobile apparatus include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The mobile apparatus 214 is commonly referred to as user equipment (UE) in UMTS applications, but may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The core network 202 is shown with several apparatus including a packet data node (PDN) gateway 208 and a serving gateway 210. The PDN gateway 210 provides a connection for the access network 204 to a packet-based network 206. In this example, the packet-based network 206 is the Internet, but the concepts presented throughout this disclosure are not limited to Internet applications. The primary function of the PDN gateway 208 is to provide user equipment (UE) 214 with network connectivity. Data packets are transferred between the PDN gateway 208 and the UE 214 through the serving gateway 210, which serves as the local mobility anchor as the UE 214 roams through the access network 204.

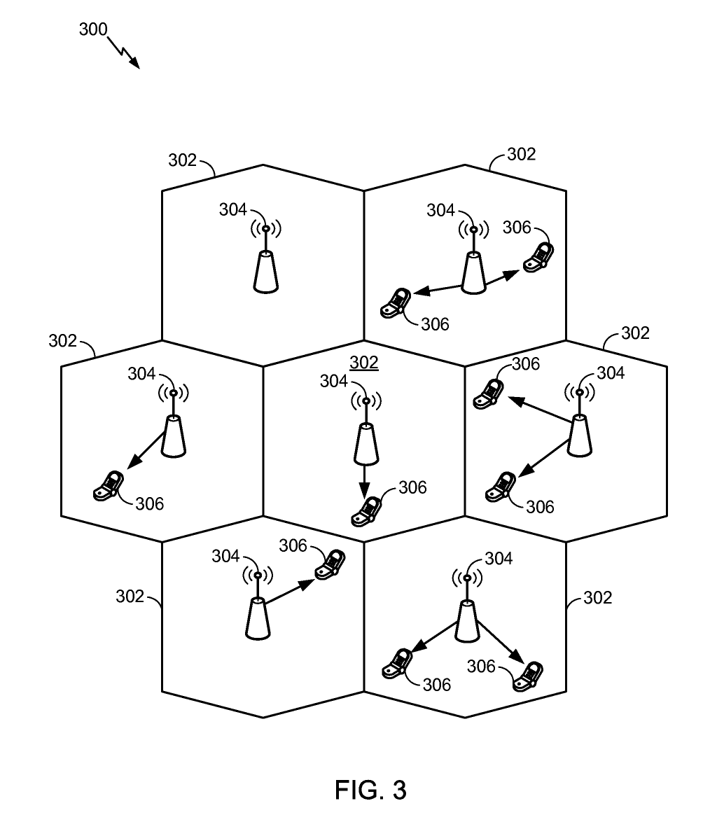

An example of an access network in a UMTS network architecture will now be presented with reference to FIG. 3. In this example, the access network 300 is divided into a number of cellular regions (cells) 302. A Node B 304 is assigned to a cell 302 and configured to provide an access point to a core network 202 (see FIG. 2) for all UEs 306 in the cell 302. There is no centralized controller in this example of an access network 300, but a centralized controller may be used in alternative configurations. The Node B 304 may be responsible for all radio related functions including radio bearer control, admission control, mobility control, scheduling, security, and connectivity to the serving gateway 210 in the core network 202 (see FIG. 2).

The modulation and multiple access scheme employed by the access network 300 may vary depending on the particular telecommunications standard being deployed. In UMTS applications, direct sequence wideband code division multiple access (DS-WCDMA) is utilized to support one or more of frequency division duplexing (FDD) or time division duplexing (TDD). As those skilled in the art will readily appreciate from the detailed description to follow, the various concepts presented herein are well suited for UMTS applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The Node B 304 may have multiple antennas supporting MIMO technology. The use of MIMO technology enables the Node B 304 to exploit the spatial domain to support spatial multiplexing, beamforming, and transmit diversity.

Spatial multiplexing may be used to transmit different streams of data simultaneously on the same frequency. The data steams may be transmitted to a single UE 306 to increase the data rate or to multiple UEs 306 to increase the overall system capacity. This may be achieved by spatially precoding each data stream and then transmitting each spatially precoded stream through a different transmit antenna on the downlink. The spatially precoded data streams arrive at the UE(s) 306 with different spatial signatures, which enables each of the UE(s) 306 to recover the one or more the data streams destined for that UE 306. On the uplink, each UE 306 transmits a spatially precoded data stream, which enables the Node B 304 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

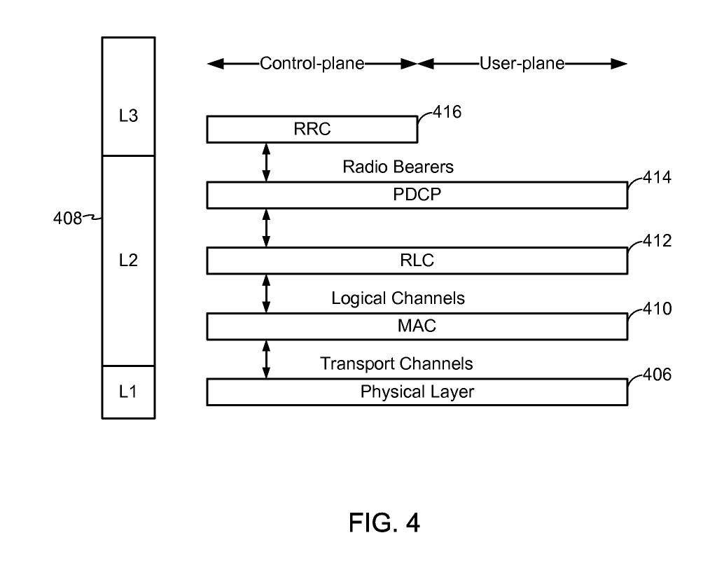

Turning to FIG. 4, the radio protocol architecture for the UE and Node B is shown with three layers: Layer 1, Layer 2, and Layer 3. Layer 1 is the lowest layer and implements various physical layer signal processing functions. Layer 1 will be referred to herein as the physical layer 406. Layer 2 (L2 layer) 408 is above the physical layer 406 and is responsible for the link between the UE and eNodeB over the physical layer 406.

In the user plane, the L2 layer 408 may include a media access control (MAC) sublayer 410, a radio link control (RLC) sublayer 412, and a packet data convergence protocol (PDCP) sublayer 414, which may be terminated at the Node B on the network side. Although not shown, the UE may have several upper layers above the L2 layer 408 including a network layer (e.g., IP layer) that is terminated at the PDN gateway 208 (see FIG. 2) on the network side, and an application layer that is terminated at the other end of the connection (e.g., far end UE, server, etc.).

The PDCP sublayer 414 provides multiplexing between different radio bearers and logical channels. The PDCP sublayer 414 also provides header compression for upper layer data packets to reduce radio transmission overhead, security by ciphering the data packets, and handover support for UEs between eNodeBs.

The UMTS RLC specification (TS 25.322, incorporated herein by reference in its entirety) defines an RLC 412 having a number of functions, among which are included segmentation and reassembly; concatenation; padding; transfer of user data; error correction; in-sequence delivery of upper layer Protocol Data Units (PDUs); ciphering; and reordering of data packets to compensate for out-of-order reception due to Hybrid Automatic Repeat reQuest (HARQ). Several types of RLC entities are defined, including Transparent Mode Data (TMD) and Acknowledged Mode Data (AMD) RLC entities. In transparent mode, any errors in received PDUs cause the respective PDUs to be discarded, leaving it up to the upper layers to recover from the data loss. In acknowledged mode, the RLC 412 recovers from errors in received data by requesting a retransmission by the UE or the network.

In general, in acknowledged mode the RLC sublayer 412 provides AMD PDUs to the MAC sublayer 410 over logical channels, and the MAC 410 multiplexes the AMD PDUs into the available transport blocks delivered to the physical layer on the transport channels. Here, the transmitting side of the AM RLC entity transmits AMD PDUs, and the receiving side of the AM RLC entity receives AMD PDUs. The MAC sublayer 410 is also responsible for allocating the various radio resources (e.g., resource blocks) in one cell among the UEs. The MAC sublayer 410 is also responsible for HARQ operations.

The UMTS MAC specification (TS 25.321, incorporated herein by reference in its entirety) defines a MAC 410 including a number of MAC entities for performing various different functions within the MAC layer. As discussed above, the RRC 416 is generally in control of the internal configuration of the MAC 410. Generally located in the Node B, MAC-hs/ehs is the MAC entity that handles HSDPA specific functions, and controls access to a transport channel called the high speed downlink shared channel (HS-DSCH). There generally is one MAC-ehs entity in the UTRAN for each cell that supports HS-DSCH transmission. Upper layers configure which of the two entities, MAC-hs or MAC-ehs, is to be applied to handle HS-DSCH functionality.

When MAC-ehs is configured, a MAC PDU for HS-DSCH generally includes one MAC-ehs header, one or more reordering PDUs, and optional padding. However, one skilled in the art will comprehend that MAC-ehs SDUs included in a MAC-ehs PDU can have different sizes and different priorities, and may be mapped to different logical channels.

In the control pane, the radio protocol architecture for the UE and eNodeB is substantially the same for the physical layer 406 and the L2 layer 408 with the exception that there is no header compression function for the control plane. The control pane also includes a radio resource control (RRC) sublayer 416 in Layer 3. The RRC sublayer 416 is responsible obtaining radio resources (i.e., radio bearers) and configuring the lower layers using RRC signaling between the Node B and the UE. That is, the RRC 416 may be in control of the internal configuration of at the MAC 406 and/or the RLC 412.

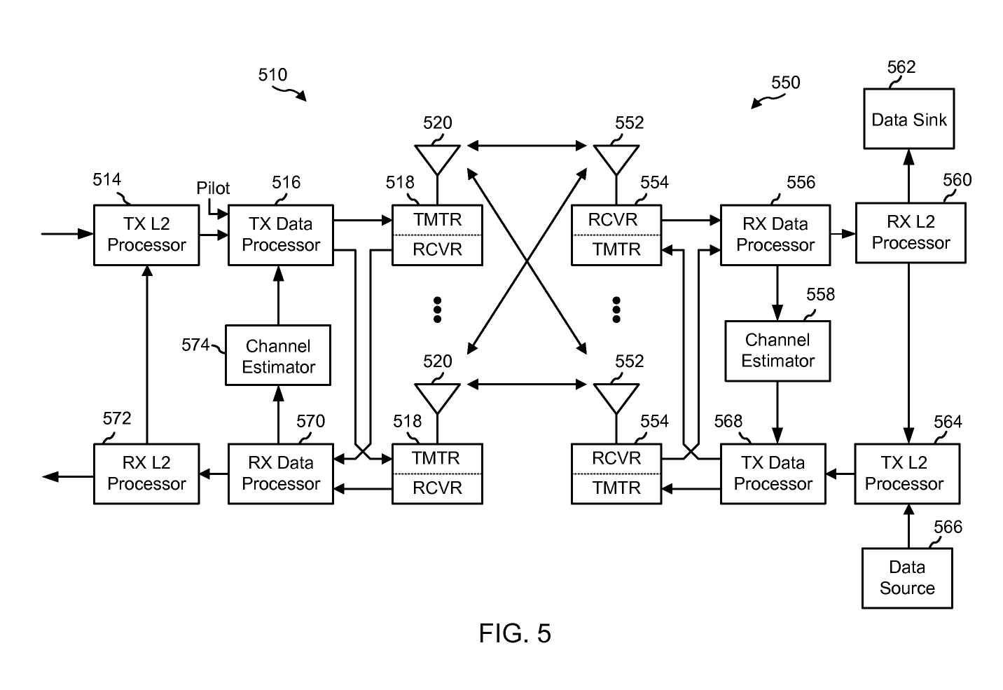

FIG. 5 is a block diagram of a Node B 510 in communication with a UE 550 in an access network. In the downlink, upper layer packets from the core network are provided to a transmit (TX) L2 processor 514. The TX L2 processor 514 may implement the functionality of the L2 layer described earlier in connection with FIG. 4. More specifically, the TX L2 processor 514 compresses the headers of the upper layer packets, ciphers the packets, segments the ciphered packets, reorders the segmented packets, multiplexes the data packets between logical and transport channels, and allocates radio resources to the UE 550 based on various priority metrics. The TX L2 processor 514 is also responsible for HARQ operations, retransmission of lost packets, and signaling to the UE 550.

The TX data processor 516 provides various signal processing functions for the physical layer. The signal processing functions include coding and interleaving the data to facilitate forward error correction (FEC) at the UE 550 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). Channel estimates from a channel estimator 574 may be used to determine the coding and modulation scheme, as well as for spatial processing. The channel estimate may be derived from a reference signal and/or channel condition feedback transmitted by the UE 550. Each spatial stream is then provided to a different antenna 520 via a separate transmitter 518. Each transmitter 518 modulates an RF carrier with a respective spatial stream for transmission.

At the UE 550, each receiver 554 generally receives a signal through its respective antenna 552. Each receiver 554 may recover information modulated onto an RF carrier, and provide the information to the receive (RX) data processor 556.

The RX data processor 556 implements various signal processing subfunctions of the physical layer. The RX data processor 556 performs spatial processing on the information to recover any spatial streams destined for the UE 550. If multiple spatial streams are destined for the UE 550, they may be combined by the RX data processor 556 into a single symbol stream. The RX data processor 556 may then convert the symbol stream from the time-domain to the frequency domain using a Fast Fourier Transform (FFT). The frequency domain signal may include a separate symbol stream for each subcarrier of a multicarrier signal. Here, the data on each subcarrier, and the reference signal, may be recovered and demodulated by determining the most likely signal constellation points transmitted by the Node B 510. These soft decisions may be based on channel estimates computed by the channel estimator 558. The soft decisions are then decoded and deinterleaved to recover the data packets that were originally transmitted by the Node B 510 on the physical channel. The recovered data packets are then provided to a RX L2 processor 560.

The RX L2 processor 560 implements the functionality of the L2 layer described earlier in connection with FIG. 4. More specifically, the RX L2 processor 560 demultiplexes the data packets between transport and logical channels, reassembles the data packets into upper layer packets, deciphers the upper layer packets, and decompresses the headers. The upper layer packets are then provided to a data sink 562, which represents all the protocol layers above the L2 layer. The RX L2 processor 560 is also responsible for error detection using an acknowledgement (ACK) and/or negative acknowledgement (NACK) protocol to support HARQ operations.

In the uplink, a data source 566 is used to provide data packets to a transmit (TX) L2 processor 564. The data source 566 represents all protocol layers above the L2 layer (L2). Similar to the functionality described in connection with the downlink transmission by the Node B 510, the TX L2 processor 564 implements the L2 layer and the TX data processor 568 implements the physical layer. Channel estimates derived by a channel estimator 558 from a reference signal or feedback transmitted by the Node B 510 may be used by the TX data processor 568 to select the appropriate coding and modulation schemes, and to facilitate spatial processing. The spatial streams generated by the TX data processor 568 are provided to different antenna 552 via separate transmitters 554TX. Each transmitter 554TX modulates an RF carrier with a respective spatial stream for transmission.

The uplink transmission may be processed at the Node B 510 in a manner similar to that described in connection with the receiver function at the UE 550. Each receiver 518 may receive a signal through its respective antenna 520. Each receiver 518 may recover information modulated onto an RF carrier and provide the information to a RX data processor 570. The RX data processor 570 implements the physical layer and the RX L2 processor 572 implements the L2 layer. Upper layer packets from the RX L2 processor may be provided to the core network.

Aspects of the disclosure may relate to data transmitted over one or both of the uplink and/or the downlink. In the uplink (e.g., utilizing DC-HSUPA), it is generally reasonable to assume that the two uplink frames and subframes are time-aligned. Further, if there are two uplinks, there are accordingly at least two downlinks. Thus, in this disclosure, these characteristics are assumed, however, one having ordinary skill in the art will comprehend that other embodiments may still exist within the scope of the claims, wherein these assumptions do not necessarily apply.

Prior to transmitting data over the downlink, the TX L2 processor 564 of the Node B generally ciphers then fragments data packets, resulting in requirements for a substantial amount of processing by the RX L2 processor 572 of the UE for each segment received. These high processing requirements may be exacerbated at high data rates, where the processing may be repeated for each data packet.

Thus, it may be more efficient to pursue a strategy of including more information in each data packet, such that the processing power required for each packet may be reduced, at the possible expense of increasing the amount of data transmitted.

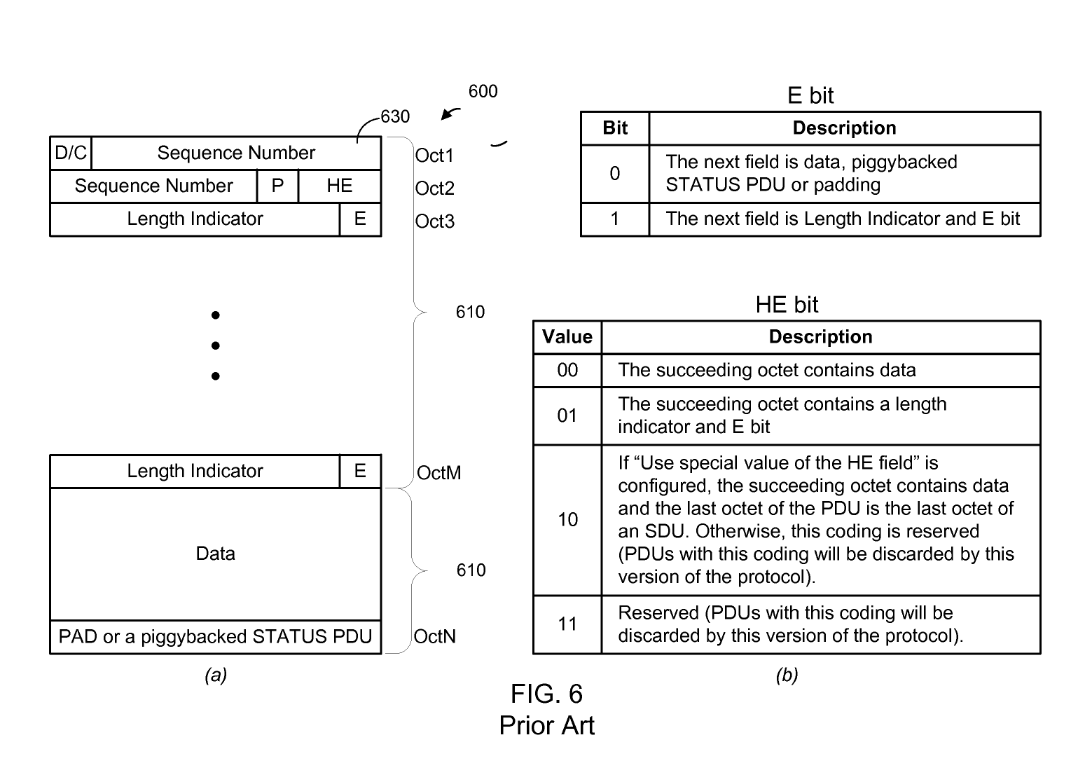

As defined in the RLC specification, an AMD PDU 600, illustrated as a bit map in FIG. 6(a), includes an RLC header 610 and an RLC payload 620. The AMD PDU 600 may be utilized to transfer user data, piggybacked status information, and a Polling bit when the RLC is operating in acknowledged mode. The length of the “Data” part is generally a multiple of 8 bits. The header 610 generally includes the first two octets of the PDU, which include the “Sequence Number” 630, the Polling bit “P,” Header Extension information “HE,” and further, contains all the octets that include “Length Indicators” and Extension bits “E”.

The “HE” and “E” bits may take various values resulting in different interpretations, as illustrated in FIG. 6(b). For example, a “HE” value of 00 indicates that the succeeding octet includes Data; a value of 01 indicates that the succeeding octet includes a length indicator and an “E” bit; a value of 10 indicates that, if the “Use special value of the HE field” is configured, the succeeding octet contains data and the last octet of the PDU is the last octet of a Service Data Unit (SDU). Otherwise, this coding is reserved, that is, may generally be discarded. Finally, a “HE” value of 11 is reserved, that is, may generally be discarded.

When the “E” bit is low, it indicates that the next field includes one of Data, piggybacked status information, or padding. When the “E” bit is high, it indicates that the next field or octet is another length indicator and “E” bit.

Thus, with this header format, for an RX L2 processor 572 or 560 to access the Data field of an AMD PDU 600, a substantial amount of calculation and processing may be required. For example, utilizing the example illustrated in FIG. 6(a), the “HE” bits in the second octet, having a value of 01, are read, indicating to the processor that the succeeding octet includes a length indicator and an E bit. Thus, the succeeding octet (Oct3) is read to find the value of the corresponding “E” bit, which is determined to have a value of 1, indicating that the next octet includes a length indicator and another “E” bit. This process is repeated for each succeeding octet, until at last octet OctM is read, to find the value of the corresponding “E” bit to finally be 0, indicating that the Data field follows.

Thus, it is seen that substantial parsing of the AMD PDU 600 may be utilized to find the beginning of the Data. Further, determining the value of the E bit requires bit operations, which are generally less efficient than byte operations. Moreover, because the header size may be variable, the processing is generally done in software, which is less efficient that processes accomplished by logic. Therefore, it is seen that the RLC header is not very optimized.

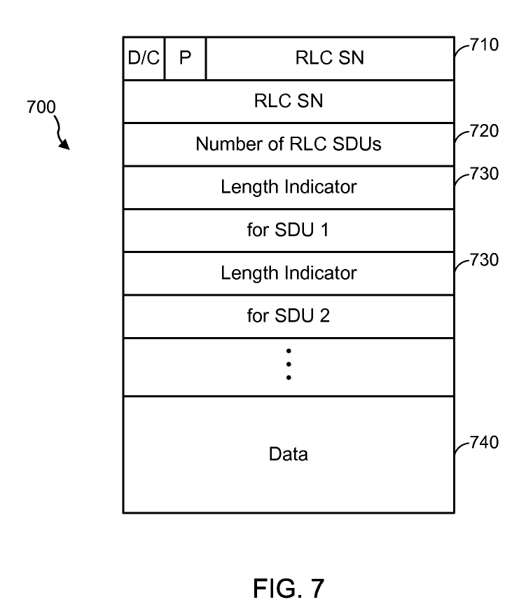

In an aspect of the disclosure an AMD PDU 700 may eliminate the HE and E bits from the RLC header, and an additional field may be included to indicate the number of RLC SDUs in the PDU 700. That is, as illustrated in FIG. 7, a “Number of RLC SDUs” field 720 may be utilized after the RLC sequence number 710. Thus, for an RX L2 processor 572 or 560 that reads the Number to access the Data field 740, the “Number of RLC SDUs” field 720 may be accessed by pointing an index to the Number IE 720 and reading the value stored therein. The processor may then, for example, multiply the number of SDUs obtained in the Number IE 720 by the length of an SDU Length Indicator 730 (e.g., 2 octets per Length Indicator), to determine where to access the beginning of the Data field 740. Then the index may be advanced by the number of length indicators 730 multiplied by the length of one of the length indicators 730, such that it points to the beginning of the Data field 740.

Referring again to FIG. 6(a), the RLC PDU 600 includes an RLC sequence number 630 within the header 610. During transmission, the sequence number 630 may be incremented for each PDU. The magnitude of the sequence number indicates the sequential ordering of the PDU in its buffer.

For example, the access network 204 (see FIG. 2) may scan the sequence numbers 630 embedded within the received PDUs 600 to determine the sequential ordering of the PDUs 600, and to determine if any PDUs 600 are missing. The access network 204 may then send a message to the UE 214 that indicates which PDUs 600 were received by using the sequence numbers of each received PDU, or may request that a PDU be re-transmitted by specifying the sequence number 630 of the PDU to be re-transmitted.

Hyper-frame numbers (HFNs) 810 may also be maintained by the UE 214 and the access network 204. Hyper-frame numbers 810 may be thought of as most significant bits (MSBs) of the sequence numbers 630, wherein the concatenation of the HFN 810 and the sequence number 630 is denoted as COUNT-C 820. When the UE 214 detects a rollover of the sequence number 630 of PDUs 600 in a receiving buffer, the UE 214 increments the HFN 810. A similar process generally occurs on the access network 204 for the HFN maintained there. Thus, to save space in the transmitted data, the HFN 810 is not generally transmitted with the PDUs 600.

The value of COUNT-C may further be utilized by the RLC 412 (e.g., the L2 processor 514, 572, 560, or 564) in order to derive a cipher key for deciphering the RLC PDU 600. However, because only a portion of COUNT-C is generally sent with the RLC PDU 600 (i.e., the sequence number 630), certain problems may arise involving corner cases when handling ciphering. For example, the UE may be asked to maintain multiple security contexts. In this example, if the UE receives a new security context it may change its HFN. Due to these and other corner cases, it is very difficult to maintain the HFN in hardware. Thus, the UE generally goes up to software to retrieve the HFN, and applies the retrieved HFN, concatenated with the sequence number, in the ciphering algorithm. Those skilled in the art will comprehend that this procedure being performed for each RLC PDU 600 may result in the use of significant processing resources.

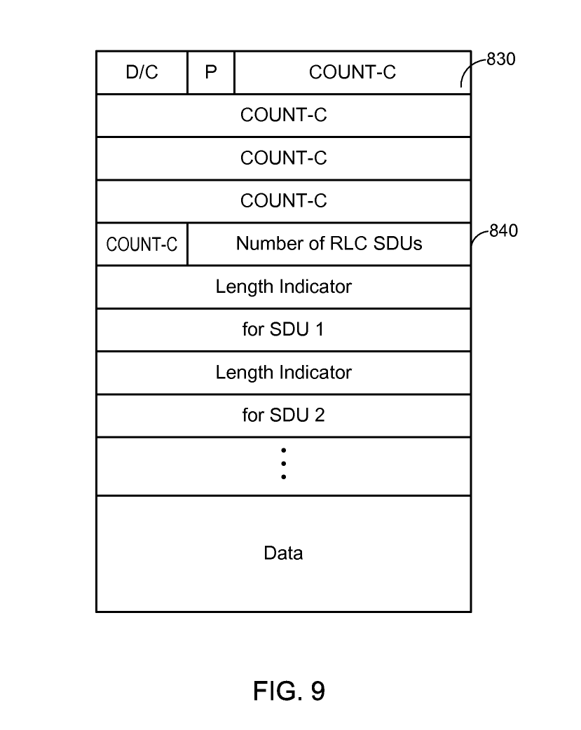

Thus, in an aspect of the disclosure, as illustrated in FIG. 9, an RLC PDU 900 may include the entire 32-bit COUNT-C. In this way, the UE is enabled to generate a cipher key for the RLC PDU 900 based on information within the RLC PDU 900 without utilizing software to retrieve the HFN. Those skilled in the art will recognize that the addition of 20 bits (i.e., the RLC HFN 810) to the header of the RLC PDU 900 would result in extra overhead, this tradeoff is generally acceptable when, as described above, an air interface utilizing MIMO and/or dual channels (or more) enables very high packet data rates, so the reduced processing thusly enabled may be an acceptable cost.

In yet another aspect of the disclosure, segmentation of RLC PDUs may be disallowed during a particular transmission time interval (TTI) if the number of RLC PDUs transmitted during that TTI is greater than some threshold (e.g., a predetermined threshold). Segmented RLC PDUs, as allowed by the MAC-ehs entity, may add significantly to UE processing. In particular, the UE may not be able to decipher segments of RLC PDUs until all of the segments have been received by the UE. This situation can lead to burstiness in the UE's processing of received packets, where the UE sits idle waiting for large packets, then executes short intensive bursts of processing to decipher the packets after all segments have arrived.

Thus, the MAC layer of the network may be disallowed from segmenting RLC PDUs if the number of RLC PDUs in a TTI is larger than a fixed number. This will reduce or prevent the segmentation-related increased processing when the number of RLC PDUs in a TTI is large. In one aspect of the disclosure, the threshold may be smaller than a maximum number of RLC PDUs allowed in the TTI.

One potential disadvantage is that disallowing segmentation may reduce data throughput. Table 1 shows the difference in percentage of bits of data that may be carried between (i) always enabling MAC segmentation and (ii) disallowing MAC segmentation beyond a certain number of RLC PDUs in a TTI. Results are shown for different RLC PDU sizes, and different limits on the number of RLC PDUs beyond which MAC segmentation is disallowed. Each transport block set (TBS) is assumed to occur with equal probability.

TABLE 1
Effect of disallowing MAC segmentation

| | | | | | RLC PDU | RLC PDU |
|---|---|---|---|---|---|---|
| | RLC PDU | RLC PDU | RLC PDU | RLC PDU | Size = | Size = |
| | Size = 40 | Size = 100 | Size = 200 | Size = 500 | 1000 | 1500 |
| | Bytes | Bytes | Bytes | Bytes | Bytes | Bytes |
| MAC | 1.5% | 2.66% | 4.02% | 5.52% | 4.79% | 1.22% |
| Segmentation | | | | | | |
| Disallowed | | | | | | |
| after 3 RLC | | | | | | |
| PDUs per | | | | | | |
| stream | | | | | | |
| MAC | 1.23% | 2.01% | 2.73% | 2.42% | 0% | 0% |
| Segmentation | | | | | | |
| Disallowed | | | | | | |
| after 6 RLC | | | | | | |
| PDUs per | | | | | | |
| stream | | | | | | |

The loss due to disallowing MAC segmentation is seen to be quite small, particularly when MAC segmentation is disallowed after 6 μLC PDUs per stream. The actual loss may be even smaller than the one shown since (a) these results assume a single-user system, where the scheduler generally uses up all codes and power for a single user, and (b) even in a single user system, the TBSs in the case of no MAC segmentation are on the average smaller than with MAC segmentation, so they will generally have a higher probability of decoding (given the same power). This second effect has not been captured in these results.

In yet another aspect of the instant disclosure, a hard limit may be placed on the number of PDUs allowed to be transmitted in a given TTI. Because each RLC PDU is generally deciphered separately, the processing load of the UE may be directly related to the number of RLC PDUs in a TTI. That is, because each RLC PDU may be a separate block that must be deciphered separately, the number of RLC PDUs carried in one transport block over the air determines a portion of the amount of processing executed by the UE. Thus, a suitable limit on the number of PDUs allowed to be sent in a TTI may on average reduce the processing load of the UE. If the maximum number of PDUs is low, it generally forces larger PDUs to be utilized to achieve the desired peak data rate. Processing-wise, it does not change much, because processing generally depends on the number of PDUs, not their size.

In another aspect, the instant disclosure enables the handling of high data rates at the Media Access Control (MAC) layer in the UE. That is, as discussed above, the MAC sublayer 410 may utilize a MAC-ehs entity for handling a high speed downlink shared channel (HS-DSCH).

The MAC-ehs entity may be utilized in the handling of functions specific to high-speed downlink packet access (HSDPA), and controlling access to a transport channel of a high-speed downlink shared channel (HS-DSCH). For a UE in HSDPA, physical channels may include a high speed physical downlink shared channel (HS-PDSCH) for transferring payload data, and a high speed physical control channel (HS-DPCCH) for uploading an acknowledgement/negative acknowledgement (ACK/NACK) and a channel quality identifier (CQI). As for the MAC sublayer of the HSDPA UE, the MAC-ehs entity utilizes a transport channel of the HS-DSCH for receiving data from the physical layer. In addition, a shared control channel for HS-DSCH (HS-SCCH) may be utilized as a physical downlink channel, responsible for transmission of control signals corresponding to HS-DSCH, such as UE identities, channelization code sets, modulation schemes, and transport block sizes, so that the UE can correctly receive data packets from HS-DSCH.

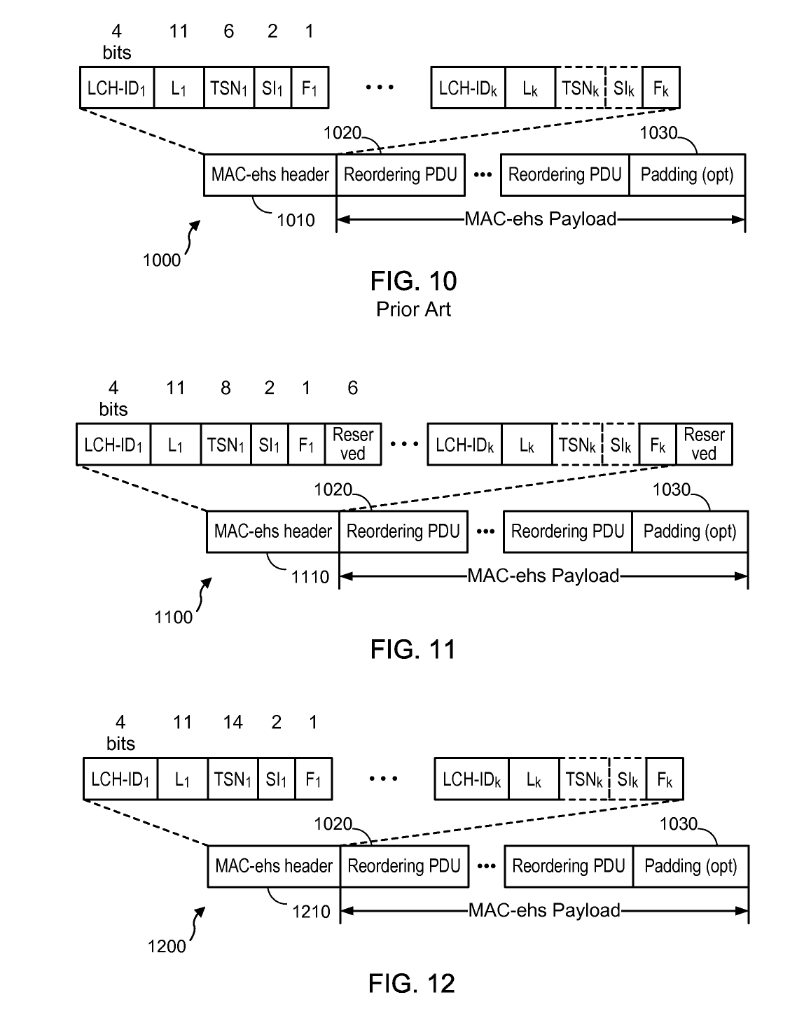

FIG. 10 illustrates a schematic diagram of a conventional MAC-ehs Protocol Data Unit (PDU) 1000. The conventional MAC-ehs PDU 1000 may be a transmission packet utilized by the MAC-ehs entity, and may include a MAC header 1010, at least one MAC service data unit (SDU) or Reordering PDU 1020, and optional padding 1030. In general, each reordering PDU 1020 includes one or more reordering SDUs belonging to the same priority queue. All reordering SDUs belonging to the same priority queue in one TTI are generally mapped to the same reordering PDU. Each reordering SDU may be a complete MAC-ehs SDU or a segment of a MAC-ehs SDU.

In the MAC-ehs header 1010, a 4-bit logical channel identifier (LCH-ID) provides identification of the logical channel at the receiver and the re-ordering buffer destination of a reordering SDU. An 11-bit Length indicator (L) provides the length of the reordering SDU, in octets. The LCH-ID and L fields are generally repeated per reordering SDU. A 6-bit Transmission Sequence Number (TSN) field provides an identifier for the transmission sequence number on the HS-DSCH; a 2-bit segmentation indication (SI) indicates whether the MAC-ehs SDU has been segmented; and a 1-bit Flag (F) indicates whether more fields are present in the MAC-ehs header. The TSN and SI fields are generally repeated per reordering PDU.

Further information about the MAC PDU may be found in the 3GPP MAC specification, 25.321, incorporated herein by reference.

In the MAC-ehs header 1010, the TSN, having 6 bits, enables the addressing of 2⁶ or 64 packets. For a single carrier, 64/8=8, which is thus the maximum number of re-transmissions before stalling, assuming an 8-long HARQ process. On the other hand, for DC or MIMO, 64/8/2=4, because two carriers can be sent at a time. Similarly, for DC+MIMO, the maximum number of re-transmissions before stalling is 2, because 4 carriers may be sent at a time. Moreover, if 4 carriers were to be utilized in an embodiment with MIMO, only one re-transmission would be possible. Thus, to return to the range of 4 retransmissions even in the case of 4 carriers+MIMO, the TSN field may be expanded to include two more bits, i.e., 8 bits. However, if the MAC-ehs header is modified for a longer TSN field, other changes to the header may be implemented to remain byte aligned. In an aspect of this disclosure, a MAC-ehs header includes six reserved bits in addition to the two-bit expansion of the TSN field. In this way, the MAC-ehs header remains byte aligned.

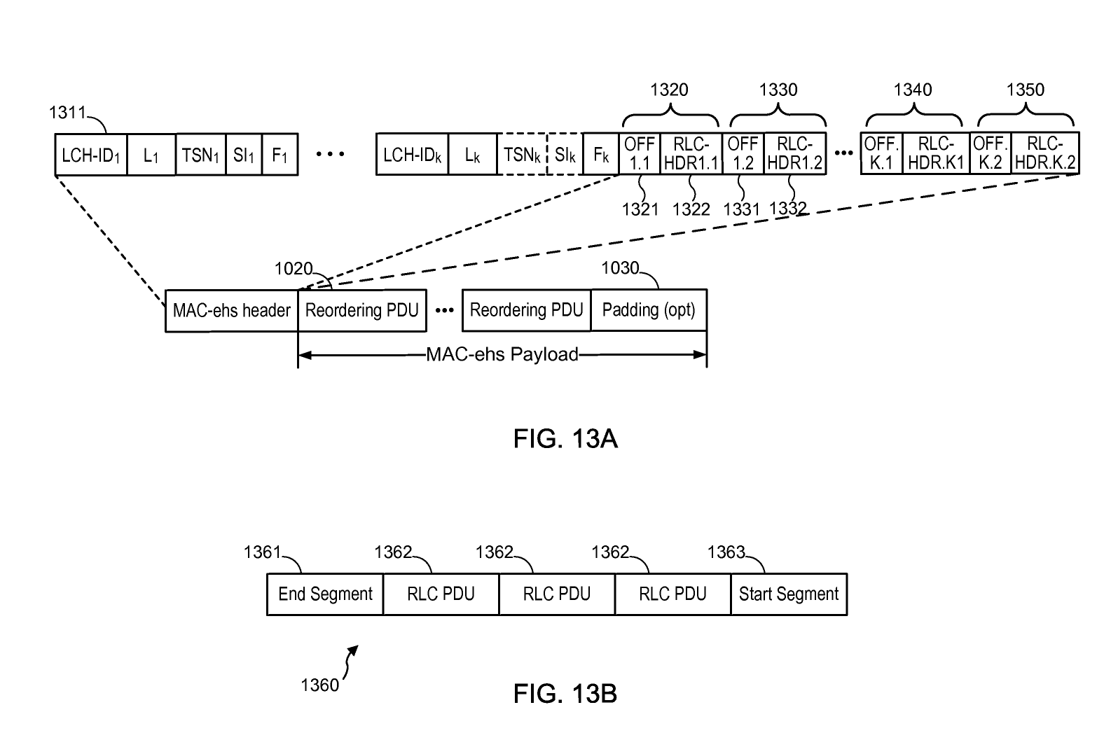

FIG. 11 is a bitmap illustrating an aspect of the disclosure in which 6 reserved bits are added to the MAC-ehs header 1110, and the TSN field is expanded to 8 bits in length. Here, the reserved bits may be set to a predetermined, fixed value, or they may be utilized for other purposes, as will be understood by those skilled in the art. In yet another aspect of this disclosure, the SI field may be removed to compensate for the additional two bits in the expanded TSN field. In some aspects of this disclosure, as discussed below, segmentation of MAC-ehs PDUs is disallowed in many cases, such that the removal of this field would not cause any tradeoffs. In some aspects, MAC-ehs PDUs may be segmented; however, the removal of the SI field may still be utilized.

In another aspect of this disclosure, the TSN is expanded to 14 bits in length, enabling the addressing of 2″ or 16,384 bits. In this way, substantial increases in packet rates are enabled while remaining byte-aligned. FIG. 12 is a bitmap illustrating an aspect of the disclosure in which the MAC-ehs header 1210 includes a TSN that is 14 bits in length.

In another aspect of the disclosure, the optional padding field 1030 of the MAC-ehs PDU 1000 may be utilized to provide the UE information about the downlink. That is, in a conventional UE, when the UE enters into a Cell DCH state, the UE may continue to utilize certain power-hungry functions regardless of whether there is an ongoing data transmission or DTX. However, if suitable information is provided to the UE on the downlink, such as to enable the UE to predict or estimate the downlink traffic flow in the future (e.g., in the next tens or hundreds of subframes), the UE may prepare in advance to turn on or turn off those power-hungry functions. For example, the UE may receive downlink buffer status within the padding field 1030. That is, status information of a buffer in the network that buffers the downlink traffic may be appended to the MAC-ehs PDU in the padding field 1030, such that the UE may read and suitably respond to the downlink buffer status. In one example, such a response to information that the buffer is empty may be for the UE to turn off a block that is utilized to process information sent on the downlink.

In another example, the UE may receive status details about the ongoing downlink traffic, the status details being such information as a type, class, volume, pattern, statistics, history (past, present, future) per logical channel, per flow, per priority, etc. That is, the network may perform traffic prediction or estimation for the UE, and send corresponding status information in the available padding fields 1030. In this way, the network may perform downlink traffic estimation and the UE may perform a power saving function accordingly.

In another example, the UE may receive some raw or minimum status information in the padding field 1030 to the UE. In this way, the UE may perform traffic estimation based on the traffic status information provided in the padding field 1030, and the UE may also perform the power saving function accordingly.

In another aspect of the disclosure, segmentation of MAC PDUs is disallowed under certain circumstances. Recall that, as discussed above, the PDUs may be segmented as they go over the air. For example, imagine a scenario in which 1000 bits of data are to be sent over the air, but the PDU size is 800 bits. Thus, a first PDU may include 800 bits of the 1000 bits of data, and the next PDU may include the remaining 200 bits. Here, the next 600 bits of the second PDU may be allocated to the next piece of data to go over the air. Segmentation, however, may be costly for the UE, because the UE generally keeps the segments in its MAC queue, and it waits until the remaining segments arrive to decipher PDUs. If the access network has a fairly large number of PDUs in a particular physical transport block, there may be no need to fit half, or a quarter in another transport block. Thus, segmentation may be disallowed when a suitable number of PDUs fits in the transport block. Various aspects of the instant disclosure disallow MAC segmentation based on one or more of a number of such factors, including a ratio of an RLC PDU size to a transport block size being greater than a threshold; a data rate of the wireless communication being greater than a threshold; a transport block size being greater than a threshold; a number of RLC PDUs in a first transport block being greater than a threshold; the wireless communication utilizing MIMO; and/or the wireless communication utilizing greater than one 5 MHz carrier channel.

In yet another aspect of the disclosure, illustrated in FIGS. 13A and 13B, sufficient information may be provided in the MAC-ehs header 1310 to enable the deciphering of partial (i.e., segmented) RLC PDUs or MAC SDUs in a given transport block. That is, segmented RLC PDU(s) within a MAC reordering SDU may be the end segment of the RLC PDU, the beginning segment of the RLC PDU, or, in a case of a large RLC PDU, a middle segment of the RLC PDU with both the beginning and end portions truncated. In general, each packet from the upper layers may be independently deciphered. However, when the ciphered packets are segmented by the RLC and/or MAC and sent to the UE, the segments may arrive out of order, and it may take a relatively large amount of time until all of the fragments of the ciphered packet arrive. Conventional implementations generally wait until the entire packet arrives and is put back together, in order to enable deciphering of the defragmented packet. Thus, conventional implementations are relatively I/O intensive, and may result in bursty processing, that is, where the UE sits relatively idle while awaiting remaining fragments of a ciphered packet, and then performs a short burst of intense processing to decipher a large packet when the final fragments arrive.

In the bitmap illustrated in FIG. 13B, a MAC SDU 1360 includes the end segment 1361 of a first RLC PDU, three complete RLC PDUs 1362, and the start segment 1363 of a second RLC PDU. Here, the term “start segment” refers to the beginning of an RLC PDU, generally including at least the beginning of the RLC header, and the term “end segment” refers to the end of the RLC PDU. The current aspect of the disclosure enables the deciphering of each portion of the MAC SDU 1360, including the start segment 1363 and the end segment 1361. In this way, the processing at the UE may be more evenly spread out in time compared to an implementation that waits for each whole RLC PDU.

In the MAC-ehs header 1310 illustrated in FIG. 13, information 1320 includes OFF1.1 1321 and RLC-HDR1.1 1322, referring to an offset and RLC header information for the first partial RLC PDU (the end segment 1361 of the first RLC PDU in this example) in the logical channel identified by LCH-ID1.1 1311. That is, the nomenclature “1.1” as used herein refers to logical channel 1 (the number to the left of the decimal), and partial or segmented RLC PDU 1 (the number to the right of the decimal). Thus, RLC-HDRa.b refers to the RLC Header information 1332 corresponding to partial or segmented RLC PDU b sent over logical channel a. Information 1330 includes OFF 1.2 1331 and RLC-HDR1.2 1332, referring to an offset and RLC header information for the second partial RLC PDU (the start segment 1363 of the second RLC PDU in this example) in the logical channel identified by LCH-ID1 1311. In general, the offset and RLC header information for a given RLC PDU may only be necessary for a segmented RLC PDU, as will be described below.

Thus, information about the segmented RLC PDUs (i.e, the start segment 1363 and the end segment 1361) from their RLC headers, discussed above, may be added to the MAC-ehs header 1310 so that the MAC 410 may determine cipher keys for the segmented packets 1361 and 1363 without needing to wait for the remaining segments of the packet, thus reducing the processing overhead compared to systems that need to wait for all the segments of a segmented RLC PDU in order to access this information from the RLC header. Some examples of this additional information in the MAC-ehs header may include an RLC sequence number, an offset element, a PDU type indicator indicating whether the segmented RLC PDU is a data PDU or a control PDU, etc. Thus, as illustrated in FIG. 13A, information 1320, 1330, 1340, and 1350 may be added to the conventional MAC-ehs header.

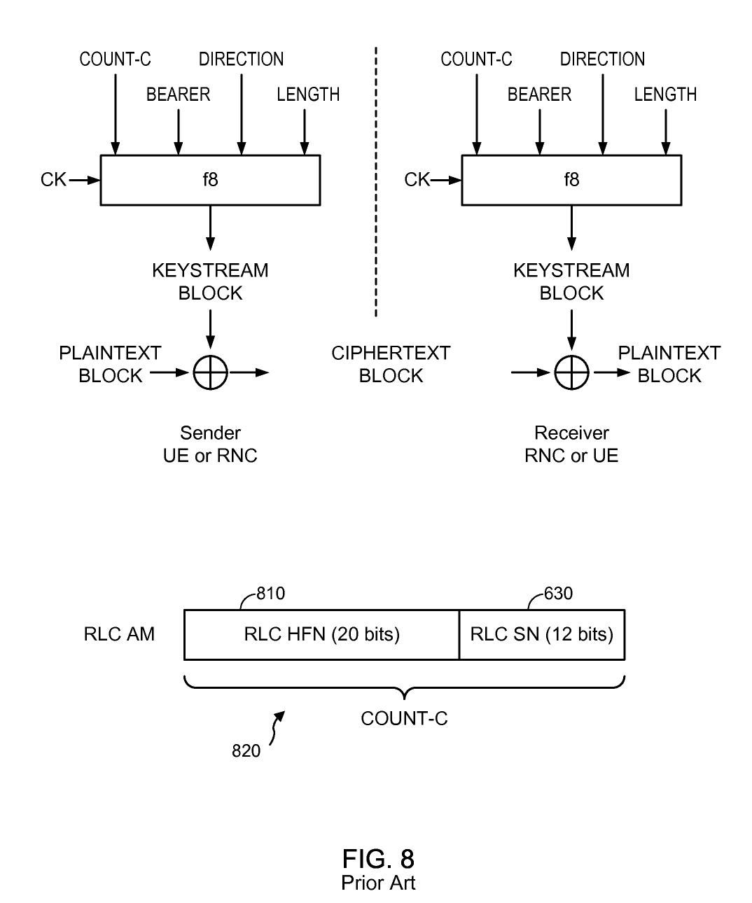

For example, the element RLC-HDR1.1 1322 may be an RLC sequence number (SN), such as the element SN 630 illustrated in FIGS. 6 and 8, corresponding to the end segment 1361 of the “first” RLC PDU transmitted over logical channel “1.” As illustrated in FIG. 6a, the SN 630 is generally contained within the first two bytes (i.e., the two most significant bytes) of the RLC header. Thus, in some aspects of the instant disclosure, the RLC-HDR information 1322 and 1332 may simply be the first two bytes from the corresponding RLC PDU. That is, although the RLC sequence number may have different lengths depending on the implementation, in some aspects the MAC may simply take the first two bytes from the RLC PDU irrespective of the contents of those two bytes, and a later process is utilized to determine which portion of these two bytes includes the RLC sequence number. In other aspects, the RLC-HDR information 1322 and 1332 may be precisely the RLC sequence number, provided directly by the RLC. In yet other aspects, the MAC may extract the RLC sequence number from the MAC SDU, and place this extracted RLC sequence number into the RLC-HDR information 1322 and 1332.

Thus, in some aspects of the instant disclosure, the RLC-SN may be fixed to two bytes in length, with at least a portion of those two bytes including the actual RLC sequence number. In this manner, there is no need for the MAC to understand the RLC header format on the transmit side. However, certain implementations may include either a 7-bit or a 12-bit RLC-SN. In these implementations, the MAC may further embed a header length indicator (not illustrated) to indicate whether the RLC-SN is 7 or 12 bits. For example, if the header length indicator takes a value of 0, it may indicate that the RLC-SN is 7 bits in length, and if the header length indicator takes a value of 1, it may indicate that the RLC-SN is 12 bits in length.

Further, a Segment Offset (OFF), e.g., OFF1.1 1321, may be included in the MAC-ehs header. Here, OFF may indicate the offset, in bytes, of the segmentation of the PDU inside the RLC PDU, that is, information indicating where the segmentation of the RLC PDU took place. The OFF element may be two bytes in length to preserve byte-alignment, however, those skilled in the art will comprehend that the length of the OFF element may be greater or less than this length without departing from the scope of this disclosure.

In another aspect of the instant disclosure, the information 1330 and 1350, providing information from the second segmented RLC PDU (i.e., the start segment of the second RLC PDU in this example) for each logical channel is optional, and may be omitted. That is, the second segmented RLC PDU is described here as the start segment 1363 of the second RLC PDU. The start segment means that it is the segment including the beginning portions of this PDU, thus, including at least the first few bytes of the RLC PDU. As illustrated in FIGS. 6 and 7, the RLC sequence number is generally within the first two bytes of the RLC PDU. Thus, even though this RLC PDU is segmented, by virtue of it being the beginning segment of the RLC PDU, it will already include the RLC sequence number, so this information may be omitted from the MAC header. Further, because the “start segment” is inherently at the beginning of the PDU, it is clear that the offset is zero. Thus, both pieces of information (i.e., the sequence number and the offset) within information 1330 and 1350 may be omitted.

One having skill in the art will recognize that similar operations (including information from the RLC, such as an RLC sequence number and an offset in a MAC header as described above to enable deciphering of segmented PDUs) may be applied on the uplink as well as the downlink, still within the scope of the instant disclosure.

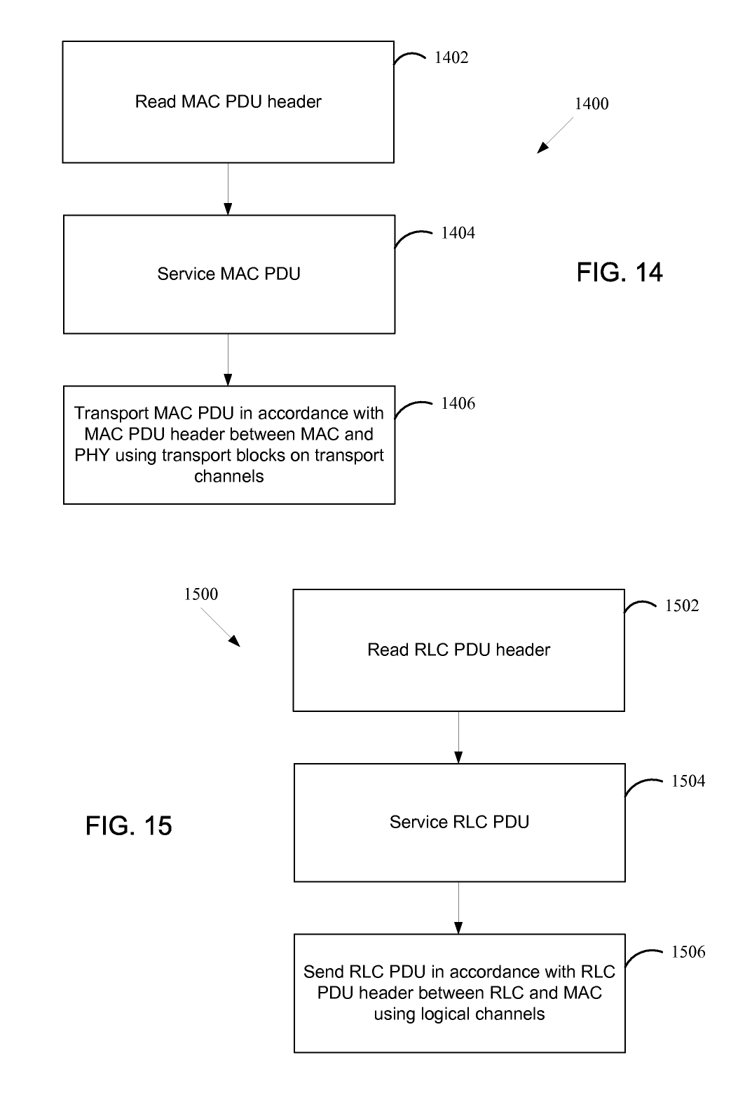

FIGS. 14 and 15 are flow charts illustrating exemplary processes according to simplified aspects of the disclosure. In some aspects, the processes 1400, 1500 may be implemented by the processing system of FIG. 1; or by the L2 processors 560, 564 in the UE 550; or by the L2 processors 514, 572 in the Node B 510 illustrated in FIG. 5.

For example, referring to FIG. 14, in block 1402, the process 1400 reads the MAC PDU header. In block 1404, the process 1400 services the MAC PDU. Servicing the MAC PDU may include segmenting or concatenating PDUs, disallowing segmentation of the PDU, ciphering or deciphering the PDU, adding or removing padding to the PDU, or another suitable process step as will be understood to those skilled in the art. In block 1406, the process 1400 transports the MAC PDU, in accordance with the MAC header, between the MAC and PHY layers utilizing transport blocks on transport channels.

Referring now to FIG. 15, in block 1502, the process 1500 reads the RLC PDU header. In block 1504, the process 1500 services the RLC PDU. Servicing the RLC PDU may include segmenting or concatenating PDUs, reading and/or modifying SDUs in the PDU, ciphering and/or deciphering the PDU, or another suitable process step as will be understood to those skilled in the art. In block 1506, the process 1500 sends the RLC PDU, in accordance with the RLC header, between the RLC and MAC layers utilizing logical channels.

It is understood that the specific order or hierarchy of steps in the processes disclosed is an illustration of exemplary approaches. Based upon design preferences, it is understood that the specific order or hierarchy of steps in the processes may be rearranged. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

1. An apparatus for wireless communication over a radio link, comprising:
a processing system configured to service a MAC protocol data unit (PDU), the MAC PDU comprising a MAC header and at least one reordering PDU, the MAC header comprising:
a transmission sequence number (TSN) having a length greater than 6 bits,
wherein the processing system is further configured to read the MAC header and transport the MAC PDU in accordance with the MAC header between a MAC layer and a PHY layer of the apparatus utilizing one or more transport blocks over one or more transport channels.

2. The apparatus of claim 1, wherein the TSN comprises 14 bits.

3. The apparatus of claim 1, wherein the TSN comprises 8 bits.

4. The apparatus of claim 3, wherein the MAC header further comprises a 6-bit reserved element.

5. The apparatus of claim 1, wherein the processing system is further configured to disallow segmentation of the at least one MAC PDU under at least one of the following conditions:
a ratio of an RLC PDU size to a transport block size is greater than a first predetermined threshold;
a data rate of the wireless communication is greater than a second predetermined threshold;
a transport block size is greater than a third predetermined threshold;
a number of RLC PDUs in a first transport block is greater than a fourth predetermined threshold;
the wireless communication utilizes MIMO; or
the wireless communication utilizes greater than one 5 MHz carrier.

6. The apparatus of claim 1, wherein the at least one reordering PDU comprises at least one segmented RLC PDU, and wherein the MAC header is adapted to enable the at least one segmented RLC PDU to be deciphered independent of any other segment of the at least one segmented RLC PDU.

7. The apparatus of claim 6, wherein the MAC header further comprises the two most significant bytes of the at least one segmented RLC PDU.

8. The apparatus of claim 6, wherein the MAC header further comprises an RLC sequence number from the at least one segmented RLC PDU.

9. The apparatus of claim 8, wherein the RLC sequence number comprises 12 bits.

10. The apparatus of claim 8, wherein the RLC sequence number comprises 7 bits.

11. The apparatus of claim 8, wherein the MAC header further comprises a length indicator to indicate a length of the RLC sequence number.

12. The apparatus of claim 6, wherein the MAC header further comprises an offset element from the RLC layer, the offset element for indicating a segmentation offset of the segmented RLC PDU.

13. The apparatus of claim 6, wherein the MAC header further comprises a PDU type indicator to indicate whether the at least one segmented RLC PDU is a data PDU or control PDU.

14. The apparatus of claim 1, wherein the MAC PDU further comprises a padding field, the padding field comprising information relating to a status of a downlink.

15. The apparatus of claim 14, wherein the information relating to the status of the downlink comprises a downlink buffer status.

16. The apparatus of claim 14, wherein the information relating to the status of the downlink comprises at least one of a type, class, volume, pattern, statistic, or history of the downlink.

17. An apparatus for wireless communication over a radio link utilizing a MAC layer and an RLC layer, comprising:
a processing system configured to service an RLC protocol data unit (PDU), the RLC PDU comprising an RLC header and an RLC payload comprising at least one RLC service data unit (SDU), the RLC header comprising:
an RLC sequence number; and
an information element for indicating a number of RLC SDUs in the RLC PDU,
wherein the processing system is further configured to read the RLC header and send the RLC PDU in accordance with the RLC header between an RLC layer and a MAC layer utilizing one or more logical channels.

18. The apparatus of claim 17, wherein the RLC header further comprises at least one length indicator for indicating a length of a corresponding RLC SDU in the RLC PDU.

19. The apparatus of claim 17, wherein the processing system is further configured to:
locate the information element for indicating the number of RLC SDUs within the RLC PDU; and
determine a starting address for the RLC payload in accordance with the number of RLC SDUs within the RLC PDU.

20. The apparatus of claim 19, wherein the determining of the starting address for the RLC payload comprises advancing an index addressed to the information element for indicating the number of RLC SDUs within the RLC PDU, by the number of length indicators multiplied by the length of one of the length indicators.

21. The apparatus of claim 17, wherein the RLC header further comprises a COUNT-C, the COUNT-C comprising the RLC sequence number and the RLC hyper frame number for a respective RLC SDU in the RLC PDU.

22. The apparatus of 17, wherein the processing system is further configured to disallow segmentation of RLC PDUs in a first transmission time interval (TTI) if the number of RLC PDUs transmitted during the first TTI is greater than a predetermined threshold.

23. A method of wireless communication over a radio link, comprising:
servicing a MAC protocol data unit (PDU) comprising a MAC header and at least one MAC service data unit (SDU), the MAC header comprising a transmission sequence number (TSN) having a length greater than 6 bits;
reading the MAC header; and
transporting the MAC PDU in accordance with the MAC header between a MAC layer and a PHY layer utilizing one or more transport blocks over one or more transport channels.

24. The method of claim 23, wherein the TSN comprises 14 bits.

25. The method of claim 23, wherein the TSN comprises 8 bits.

26. The method of claim 25, wherein the MAC header further comprises a G-bit reserved element.

27. The method of claim 23, further comprising disallowing segmentation of the at least one MAC SDU under at least one of the following conditions:
a ratio of an RLC PDU size to a transport block size is greater than a first predetermined threshold;
a data rate of the wireless communication is greater than a second predetermined threshold;
a transport block size is greater than a third predetermined threshold;
a number of RLC PDUs in a first transport block is greater than a fourth predetermined threshold;
the wireless communication utilizes MIMO; or
the wireless communication utilizes greater than one 5 MHz carrier.

28. The method of claim 23, wherein the at least one reordering PDU comprises at least one segmented RLC PDU, and wherein the MAC header is adapted to enable the at least one segmented RLC PDU to be deciphered independent of any other segment of the at least one segmented RLC PDU.

29. The method of claim 28, wherein the MAC header further comprises the two most significant bytes of the at least one segmented RLC PDU.

30. The method of claim 28, wherein the MAC header further comprises an RLC sequence number from the at least one segmented RLC PDU.

31. The method of claim 30, wherein the RLC sequence number comprises 12 bits.

32. The method of claim 30, wherein the RLC sequence number comprises 7 bits.

33. The method of claim 30, wherein the MAC header further comprises a length indicator to indicate a length of the RLC sequence number.

34. The method of claim 28, wherein the MAC header further comprises an offset element from the RLC layer, the offset element for indicating a segmentation offset of a respective RLC PDU.

35. The method of claim 28, wherein the MAC header further comprises a PDU type indicator to indicate whether the at least one segmented RLC PDU is a data PDU or control PDU.

36. The method of claim 23, wherein the MAC PDU further comprises a padding field, the padding field comprising information relating to a status of a downlink.

37. The method of claim 36, wherein the information relating to the status of the downlink comprises a downlink buffer status.

38. The method of claim 36, wherein the information relating to the status of the downlink comprises at least one of a type, class, volume, pattern, statistic, or history of the downlink.

39. A method for wireless communication over a radio link utilizing a MAC layer and an RLC layer, comprising:
servicing an RLC protocol data unit (PDU), the RLC PDU comprising an RLC header and an RLC payload comprising at least one RLC service data unit (SDU), the RLC header comprising:
an RLC sequence number; and
an information element for indicating a number of RLC SDUs in the RLC PDU;
reading the RLC header; and
sending the RLC PDU in accordance with the RLC header between an RLC layer and a MAC layer utilizing one or more logical channels.

40. The method of claim 39, wherein the RLC header further comprises at least one length indicator for indicating a length of a corresponding RLC SDU in the RLC PDU.

41. The method of claim 39, further comprising:
locating the information element for indicating the number of RLC SDUs within the RLC PDU; and
determining a starting address for the RLC payload in accordance with the number of RLC SDUs within the RLC PDU.

42. The method of claim 41, wherein the determining of the starting address for the RLC payload comprises advancing an index addressed to the information element for indicating the number of RLC SDUs within the RLC PDU, by the number of length indicators multiplied by the length of one of the length indicators.

43. The method of claim 39, wherein the RLC header further comprises a COUNT-C, the COUNT-C comprising the RLC sequence number and the RLC hyper frame number for a respective RLC SDU in the RLC PDU.

44. The method of claim 39, further comprising disallowing segmentation of RLC PDUs in a first transmission time interval (TTI) if the number of RLC PDUs transmitted during the first TTI is greater than a predetermined threshold.

45. An apparatus for wireless communication, comprising:
means for servicing a MAC protocol data unit (PDU) comprising a MAC header and at least one MAC service data unit (SDU), the MAC header comprising a transmission sequence number (TSN) having a length greater than 6 bits; and
means for reading the MAC header; and
means for transporting the MAC PDU in accordance with the MAC header between a MAC layer and a PHY layer utilizing one or more transport blocks over one or more transport channels.

46. An apparatus for wireless communication over a radio link utilizing a MAC layer and an RLC layer, comprising:
means for servicing an RLC protocol data unit (PDU), the RLC PDU comprising an RLC header and an RLC payload comprising at least one RLC service data unit (SDU), the RLC header comprising:
an RLC sequence number; and
an information element for indicating a number of RLC SDUs in the RLC PDU;
means for reading the RLC header; and
means for sending the RLC PDU in accordance with the RLC header between an RLC layer and a MAC layer utilizing one or more logical channels.

47. A computer program product, comprising:
a computer-readable medium comprising code for:
servicing a MAC protocol data unit (PDU) comprising a MAC header and at least one MAC service data unit (SDU), the MAC header comprising a transmission sequence number (TSN) having a length greater than 6 bits;
reading the MAC header; and
transporting the MAC PDU in accordance with the MAC header between a MAC layer and a PHY layer utilizing one or more transport blocks over one or more transport channels.

48. A computer program product, comprising:
a computer-readable medium comprising code for:
servicing an RLC protocol data unit (PDU), the RLC PDU comprising an RLC header and an RLC payload comprising at least one RLC service data unit (SDU), the RLC header comprising:
an RLC sequence number; and
an information element for indicating a number of RLC SDUs in the RLC PDU;
reading the RLC header; and
sending the RLC PDU in accordance with the RLC header between an RLC layer and a MAC layer utilizing one or more logical channels.
